(19) United States
(12) Patent Application Publication
(10) Pub. No.: US 2024/0344577 A1
(43) Pub. Date: Oct. 17, 2024

(54) METHOD AND DEVICE FOR DISPLAYING A BRAKING-READINESS POSITION FOR A MOTOR-VEHICLE PARKING BRAKE

(71) Applicant: Continental Automotive Technologies GmbH, Hannover (DE)

(72) Inventors: Christof Maron, Usingen (DE); Heinz-Anton Schneider, Niedernhausen (DE); Karsten Klein, Kleinostheim (DE)

(73) Assignee: Continental Automotive Technologies GmbH, Hannover (DE)

(21) Appl. No.: 18/294,818

(22) PCT Filed: Aug. 4, 2022
(86) PCT No.: PCT/DE2022/200177

§ 371 Date: Feb. 2, 2024

(30) Foreign Application Priority Data
Aug. 5, 2021 (DE) 10 2021 208 534.2

(51) Int. Cl. F16D 65/42; B60T 13/74; B60T 17/22; F16D 65/38; F16D 65/54; F16D 66/00; F16D 127/02

(52) U.S. Cl. CPC F16D 65/42; B60T 13/746; B60T 17/22; F16D 65/543; F16D 66/00; B60T 2220/03; B60T 2240/00; B60T 2250/00; B60T 2250/03; F16D 2065/386; F16D 2066/003; F16D 2066/005; F16D 2127/02

(57) ABSTRACT

A method for electronically activating an electromechanical actuator with the aid of an electronic unit is provided. A reversible electromotive actuator is connected to the ECU. An electric wheel brake in a motor vehicle comprises a brake stator, having a gear adjustment device for actuating and holding at least one brake lining in the direction of a brake rotor comprises means for providing an unbraked state with a release clearance between the brake lining and brake rotor. The release clearance is as minimal as possible and at the same time can be set in a wear-compensated, electrically defined way by virtue of the automatically imparting a special release clearance setting process/braking-readiness position to the motor vehicle wheel brake by way of software support.

### TECHNICAL FIELD

The present embodiments relate to an electronic motor vehicle braking system comprising an electric parking brake which serves as a motor vehicle service brake at least in an emergency.

### BACKGROUND

The requirements of modern motor vehicles differ from the known technologies of a conventional guarantee of a release clearance via roll-back sealing rings, because at present minimized release clearance is aimed for, so that undesired brake grinding is reliably prevented and, on the other hand, a braking effect which is as direct as possible with suitable wear adjustment behavior is made possible, i.e. idle travel minimization.

In a given vehicle braking system context, a method for operating a parking brake with an electric parking brake actuator is known from EP 2 214 944 B1. The actuator is driven by a DC motor that can be operated in two directions, i.e. reversible in direction of rotation. The motor has a currentlessly self-locking actuator gear drive train as usual, and is used to apply or release the parking brake. For this purpose, in order to inhibit rotation, at least one brake rotor is acted upon by at least one brake shoe, which is mounted fixed against rotation, and an electronic unit (ECU) is provided for controlling or regulating the movement of the DC motor in the actuator gear drive train, and wherein, when the parking brake is applied or released, a touchpoint of the brake shoe on the rotational member is exceeded in principle, and wherein, in order to determine said touchpoint, the first derivative of the electrical current received during the application of the DC motor is formed over time by the electronic unit (ECU).

DE 10 2015 210 431 A1 refers to a method for activating a parking brake in a vehicle, with an electromechanical braking device with an electric brake motor, which moves a brake piston with brake lining in the direction of a brake disk, wherein, in order to set a defined distance between the brake lining (brake piston) and the brake disk, the electric brake motor is first of all acted upon with a supply voltage before generating a nominal clamping force and then the supply voltage is switched off before the brake lining comes into contact with the brake disk.

The parking brake routines are considered to be capable of improvement with regard to new customer requirements, functions or configurations in modern motor vehicles. This is because there is an increasing demand for a modification of an electric parking brake in the sense of a servo (service) braking function, or an electric parking brake is intended to participate in an electronic service braking system in what is referred to as a backup or drop-back level in the event of functional errors, system degradation, etc. (because, for example, an adequate electro-hydraulic build-up of service brake pressure appears not to be possible (or no longer possible) due to system degeneration, criticality or due to a fault in the electronic service brake system/ESC). As a result, for example, the aim is also to brake a motor vehicle efficiently and sufficiently reliably even in the event of a fault (cf. Quality objective ASIL B, Guideline “Electric parking brake” according to Guideline VDA 305-100).

The basic requirement here is that the maximum permissible brake actuation (foot) force must be observed in order to maintain a legally prescribed minimum vehicle deceleration, even if a servo braking effect is not available. Such increasingly stringent requirements, even for a brake response behavior in such a drop-back level, could not previously be met with known electric parking brake systems.

### SUMMARY

An electronic unit (ECU) automatically activates the actuator by the brake lining being adjusted, by energizing of the actuator in the brake actuation direction by way of a first activation step such that the brake lining is contacted substantially without a gap by a slight touching and/or sliding contact with the brake rotor, and therefore there is no significant frictional power, that the electronic unit automatically detects successful contact, and that the electronic unit then terminates the energizing of the actuator. Thereafter, the electronic unit resets the brake lining in the brake release direction by means of reversed energizing of the actuator by way of a directly following second automatic activation step in such a way that there is a defined release clearance hairline gap between the brake lining and the brake rotor. The control unit finally terminates the second activation step automatically by braking the actuator with a subsequent interruption of the energizing of the actuator.

The process implementation is conceivable, for example, in the environment of an electromechanical service brake system, the wheel brake actuator/actuators of which each have a drive train designed to be released currentlessly. The application is in conjunction with electromechanical parking brakes, the wheel brake actuators of which have a currentlessly self-locking drive train. The implementation is realized by way of example with the aid of an electrically automated externally actuable parking brake electronic unit (EPB-ECU) and on the basis of at least one method implemented with microprocessor support as a software product comprising an electronic detection and/or electronic comparison of measured and/or determined sensor data as well as sensor data evaluated in the electronic unit (EPB-ECU). Relevant sensor data for the evaluation and process control are, by way of example, measured or determined actuator data, wheel brake data and/or vehicle driving data as well as other possibly provided data. The sensor data evaluation may include the temporal derivative thereof. The sensor data evaluation may include a comparison with predetermined and/or stored reference data, such as by way of example with defined predetermined vehicle target data as a control criterion and/or regulating criterion for the electronically controlled and/or electronically regulated release clearance setting as the actuator gear train actuation of the electric parking brake EPB.

Accordingly, a specially defined stand-by position/brake conditioning/braking-readiness position/release clearance setting is automatically defined and implemented as required by the ECU in accordance with the data comparison/sensor data evaluation. In other words, for the first time, a release clearance hairline gap is efficiently adjusted and maintained as required, i.e. an automatically wear-compensated braking-readiness position for the basically released, i.e. unbraked, wheel braking state is ensured while the vehicle is running.

Therefore, there is a possibility to dispense with temperature sensors—and also without necessarily having to provide any braking force or braking torque sensors whatsoever in the region of a wheel brake—i.e. a brake release state with a minimized released clearance is provided in such a way that an electromechanical emergency braking intervention with an accelerated effect is nevertheless made possible.

The embodiments are suitable for conventional electromechanically actuable wheel brakes of the service brake type as well as for the electromechanically driven parking wheel brakes which are designed to be currentlessly self-locking in the actuating system, wherein said parking wheel brakes in a configuration as a combined wheel brake may indeed have an electromechanically driven or an electro-hydraulically driven service brake. In other words, for example even in an application for an electronic parking brake, a rigidly predetermined release clearance setting logic or a release clearance setting device is not exclusively defined, but rather a requirement-based regulated, defined conditioning in the sense of a braking-readiness position is realized, and wherein the position is secured and fixed against further return by means of a currentlessly self-locked EPB actuator drive train. An application option therefore extends to supporting the safety or availability of by-wire braking systems. The electronic unit (ECU) automatically imparts the special release clearance adjustment—i.e. braking-readiness position—to the electromotive actuator of the electric wheel brake, such as for example the electric parking brake. Thus, the electric wheel brake/parking brake has to move to the readiness position on command or request of the electronic unit (ECU), taking into account the recognition/comparison of the vehicle driving data and vehicle target data. On the one hand, this ensures the necessary reliability under stricter actuation requirements, without causing naturally undesirable residual braking torques/brake grinding or driving instability. The description below is primarily based on the application example of an electric parking brake comprising a currentlessly locked parking brake function, in that the gear train of the actuator adjustment device is designed to be self-locking in at least one gear stage. Accordingly, an electric parking brake EPB makes it possible for the first time—at least for a limited period of time and/or as required in an unbraked vehicle driving mode—to set, and to temporarily maintain, a proportionally reduced release clearance in the region of one or more wheel brakes at least after recognition of particular vehicle driving states, automatically or at the request of the driver.

In order to alternatively or additionally open up to a driver's wishes for the purpose of arbitrarily improving a driving experience, that is, to design the function to be activatable on command, it is possible for the execution of the method to be configured such that it is able to be triggered by means of an actuation from a human-machine interface on request. Purely by way of example, it is furthermore conceivable to provide, for this purpose, an independent human-machine interface or a multifunctionally used interface, such as an interface, menu or similar, for selecting what is referred to as a driving experience mode. The routine can be assigned to a for example sportily selectable vehicle driving mode selection in a systematic connection with the necessary adjustment and regulating functions of the electronic unit (ECU), with the result that it is in principle made possible not only for an electronic unit (ECU) but alternatively or additionally also for a vehicle driver to assign the wheel brake conditioning with a reduced release clearance with release clearance hairline gap adjustment, to a sportily desired driving experience.

In a further embodiment, a boundary condition is that, when the reduced release clearance is imparted, i.e. when the actuator gear drive train approaches particularly closely in the direction of friction lining+brake rotor, a contact touchpoint is determined from information, and wherein, in order to obtain information about the contact touchpoint, no special additional sensors at all are necessary, but only a conventional brake system sensor system, which is in any case provided in every current electric vehicle braking system comprising driving stability control ESC/ESP and also comprising an electric parking brake EPB.

A boundary condition/criterion in the development of a touch-point detection according to preferred embodiments is that the motor vehicle is present in the unbraked vehicle driving state (released brake, no braking request is expressed, ESC driving stability system is without intervention), that vehicle driving stability is present without braking intervention (driving stability is monitored by the ESC control unit and evaluated as uncritical), and wherein the vehicle continues to drive in the vehicle driving mode at least at the start of the procedure (verifiable by way of example by pattern matching between gas pedal position, signals from wheel rotation sensors and vehicle acceleration sensors and/or steering angle sensors->observation of the integrated sensors provides consistently plausible values about the current vehicle driving mode under supervision of the ESC system; v>0). In this case, the sensor data, data patterns, etc. under consideration are transferred to a combined ESC+EPB electronic unit (ECU), to which the vehicle (driving) state data are in any case accessible during the vehicle driving mode, i.e. are available there for evaluation, and the method is started only in the event that there is no abnormal vehicle movement. Finally, it is possible or expedient that a determined or detected fault in a vehicle service brake system is taken as a basis for triggering the special adjustment method.

Accordingly, the present embodiments differ quite fundamentally from a conventional electric EPB parking brake control/parking brake activation, because the known EPB software technology usually exclusively focuses on the functionality for guaranteeing that a motor vehicle is parked in a motionless and currentlessly secured manner (what is referred to as a standstill manager). In contrast, the present embodiments accordingly include an organizational as well as technological “breaking of a taboo”, since this essentially allows for the first time an automated or arbitrary inclusion of EPB control clients in a normal vehicle driving mode in order to further develop a service brake functionality, driving experience, system availability or reliability or braking actuation comfort in a vehicle driving mode (v>0) (EPB host administers for the first time a dual-use application of an EPB component from the field of vehicle standstill management for the further development of an application in the vehicle driving mode at v>0).

A touchpoint detection of the wheel brake is not controlled in a monotonously rigid manner, but a touchpoint is detected adaptively by detecting and/or measuring an actuator current rise during the electrical supply of the actuator in the electronic unit (ECU). A first peak or current increase in the current requirement of the actuators refers to the no-load current measured at peak in this action for starting up, which no-load current is basically present increased in a peak-like manner as a result, so that a physically inert—as expressed by way of a model—EPB actuator gear motor drive train, including an actuated friction lining, is set into an adjustment movement with friction lining feed in the first place, from a standstill. For a robust, safe design of this, a current increase of about >=0.5 A, for example, may be required. Such an increased established current requirement may already be qualitatively sufficient for there to be a significant build-up of a braking force in the context of a touchpoint detection, such that, it is proposed as assistance to incorporate additional sensors or data relating to vehicle driving data, as well as to observe them for specific purposes and to use their behavior to obtain a favorable as well as efficient and precise control of the adjustment method.

A variant therefore consists in the fact that, as a criterion for imparting the braking-readiness position (criterion for very small release clearance, or starting criterion for the process of setting a very small release clearance), a current vehicle reference speed and/or current wheel rotation speed, available wheel rotation speed information, information on the longitudinal acceleration of the vehicle, etc. is evaluated in relation to an emerging imminent vehicle instability, and therefore, in the event of a risk to the vehicle stability, a known release clearance hairline gap position is adjusted for each wheel brake involved or selectively individually.

If, before certain vehicle data are reached and after the release clearance setting process has been started, the criterion for the touchpoint detection is already fully and reliably fulfilled from consideration of the actuator current alone, the energizing of the actuator in the brake actuation direction is immediately stopped and the gear motor drive train is subsequently actuated in reverse to provide a certain amount of adjustment in the direction of brake release for providing the brake release clearance hairline gap.

The brake slip of one or all parking-braked wheel brakes/wheels—such as rear wheels for example—can be considered as a criterion, i.e. for assessing vehicle stability, or it is possible that the slip values of a vehicle axle are evaluated and assessed together. A further refinement or increase in precision may also include consideration of additional information and/or signals, such as yaw sensors, steering sensors, e-gas sensors and/or similar sensors.

As further boundary conditions of an embodiment, there is a stipulation that a routine for reducing the release clearance takes place in a current vehicle driving situation, i.e. during the current vehicle driving mode, that is, the motor vehicle is not (yet) braked. Therefore, a release clearance e reduction routine provides verification/assurance that there is currently no braking request, but that there is currently a driving request, or the vehicle is in the driving mode (a vehicle control system/vehicle driver “steps on the gas”). In the case of a front-wheel drive vehicle, an apparent “brake slip” of 2%-7% can already be assumed in this situation as a consequence of a resulting “drive slip” (at full or partial load, e.g. on the highway) with respect to the rear axle wheels, insofar as the front wheel speeds are used as the reference speed for the present slip criteria/slip calculations.

To this extent, in a further refinement, driving state data monitoring can include not only the slip with respect to its maximum value, but rather, or in addition, the change in the slip, which is determined during the action of the approach to the disk. For this purpose, the slip of the respective rear wheel is monitored with regard to an increase by reducing the release clearance.

It should also be taken into account in other variants that, under certain circumstances, one or both wheel rotation speed information item(s) for the front axle is/are missing or an ABS controllability of the hydraulic brake can no longer be presumed, and this has to be taken into account in the slip calculation for the rear wheels, or else the longitudinal acceleration information is no longer available and the vehicle stability can no longer be directly recognized.

As a vehicle travel data criterion for the action of the specified release clearance setting, instead of a percentage-related mean slip amount, the value can also be monitored via the specific change in the respective wheel speed itself, which should not drop noticeably/significantly when a setpoint/target current value is reached.

To increase the vehicle stability, the release clearance reduction may also be performed sequentially, so that the lateral guiding force of each rear wheel is always available in any case.

Reducing the release clearance to improve the response behavior of the dynamic braking function of the EPB may also be temporally limited in the event of a fault in the electric braking system. The temporal limit can also be set depending on the vehicle speed in order to be able to prevent excessive heating of the rear axle brake due to the reduced release clearance of the EPB.

In addition to limiting the speed-dependent time window in which the release clearance is reduced, the absolute value of the release clearance itself may also be set once again in a speed-dependent manner.

A further embodiments may use at least not (solely) exclusively an actuator current for the detection of a touchpoint between the brake lining/shoe and the brake rotor. An increase in current when approaching the touchpoint should no longer (solely) be the actually limiting parameter, but the maximum permitted wheel slip of the wheel at which the touchpoint is approached for this situation. Furthermore, it is possible, conceivable and expedient to provide the criterion, i.e. the value of the maximum permitted wheel slip, in a manner defined differently depending on the speed.

The present embodiments are implementable in a flexible, forward-looking and variable manner such that, by way of example, additionally allows one or more variously mounted mechanically currentless restoring spring means to be functionally integrated or said restoring spring means or the basic necessity therefor to be streamlined, in whole or in part, at the request of the customer.

### BRIEF DESCRIPTION OF THE DRAWINGS

The embodiments are described in detail below with reference to a drawing in which an electronic braking system is explained quite generally and exemplary embodiments are specifically explained in greater detail. In the drawings:

FIG. 1 shows the architecture of a known electronic motor vehicle parking brake system in an integrated configuration with an ESC control unit as a central braking system host, including an EPB;

FIGS. 2-4 show schematically in detail exemplary embodiments of a device/method.

### DETAILED DESCRIPTION

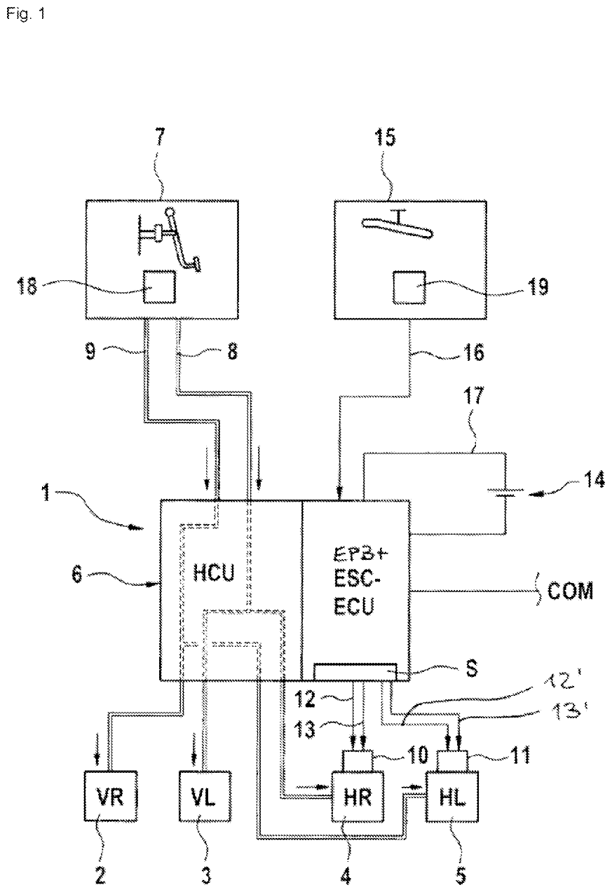

For the purposes of explanation, FIG. 1 shows an example of a generally tried and tested, and thus known, multi-circuit, electro-hydraulically actuable motor vehicle braking system 1. The latter comprises a plurality of brake calipers 2-5 (VR front right, VL front left, HR rear right, HL rear left) with hydraulically actuable actuators, which are organized in a plurality of hydraulic brake circuits, and are hydraulically connected to an electronically controlled unit 6 comprising an electronic unit (EPB+ESC−ECU) and a hydraulic unit (HCU) containing an engine-pump unit and electro-hydraulic valves for the hydraulic power supply. In this case, the hydraulically actuable actuators are actuable in a driver-initiated manner by a hydraulic actuating means 7 via continuous hydraulic lines 8, 9, and the unit 6 makes available in this context in principle an electronically controlled braking torque distribution (EBD) for the brake calipers 2-5. Another function is that the brake calipers 2-5 are actuable independently of the driver by the unit 6, for example by an electronic stability program (ESC). In order to enable a further electronic assistance function, at least some of the brake calipers 2-5 additionally or separately have highly efficient electromechanical actuators 10, 11, for example for actuating or releasing a parking brake effect on the basis of a parking brake request. The electromechanical actuators 10, 11 may be provided in connection with a disk brake, or may act on a drum brake, which are in each case for example arranged on a rear axle. The embodiments can also be applied to other friction or latching mechanisms that are used to fix vehicle wheels. At least one electrical power source 14 is electrically connected to the electronic unit ECU for the electrical supply. The same connection is used for the basic electrical supply of the unit 6 and the loads connected thereto. The electronic unit EPB+ESC−ECU is connected to the electromechanical actuators 10, 11 via in each case at least two separate electrical supply lines 12, 13. Furthermore, the electronic unit EPB+ESC−ECU has at least one electrical switching means to electrically reversibly supply the electromechanically actuable actuators 10, 11. It is understood that, when three-phase drives are used in the region of the actuators 10, 11, three supply lines can be provided without departing from the essence of the embodiments.

Said switching means may additionally have integrated means for reversing at least one of the electromechanical actuators 10, 11 to release an actuated parking brake function. The specific design of such reversing means may differ. When using a DC geared motor in the region of the actuators 10, 11, relay-like semiconductor switches can be sufficient for simply reversing the polarity of the current direction in the two supply lines 12, 13. By contrast, for example when using multi-phase, in particular brushless DC motors, preference is given to an integration of switching means which contains semiconductor switching means in what is referred to as a MOS-FET-H bridge circuit arrangement, in order to enable multi-quadrant operation.

For connecting the electronic unit EPB+ESC−ECU to its peripherals, such as for example the actuators 10, 12, at least one additional electrical interface S, for example with at least one additional electrical plug-in element, is used for the electrical connection to the at least two electrical supply lines 12, 13; 12′, 13′. A bus connection COM is provided for the integration and communication of the ESC+EPB−ECU within a vehicle network topology. Further attachments or connections of actuation sensors 18, 19, wheel rotation sensors for wheel slip detection, pressure sensors or similar are not illustrated.

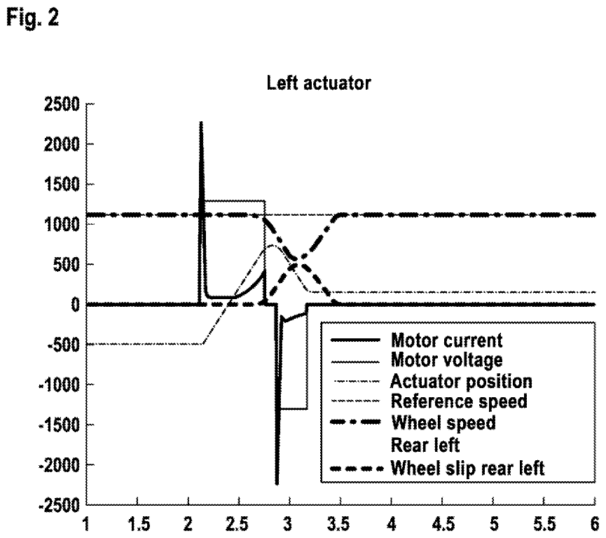

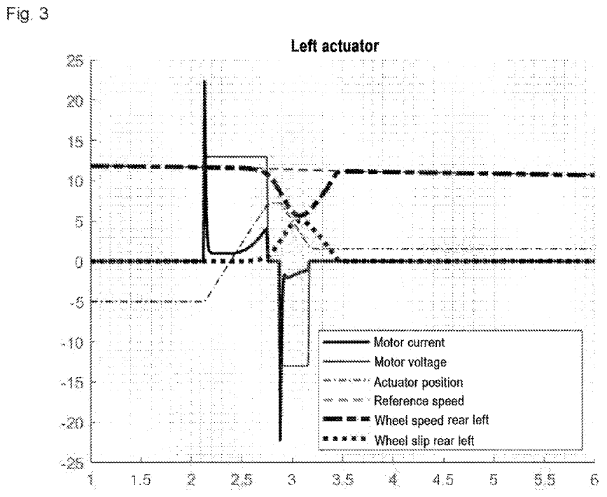

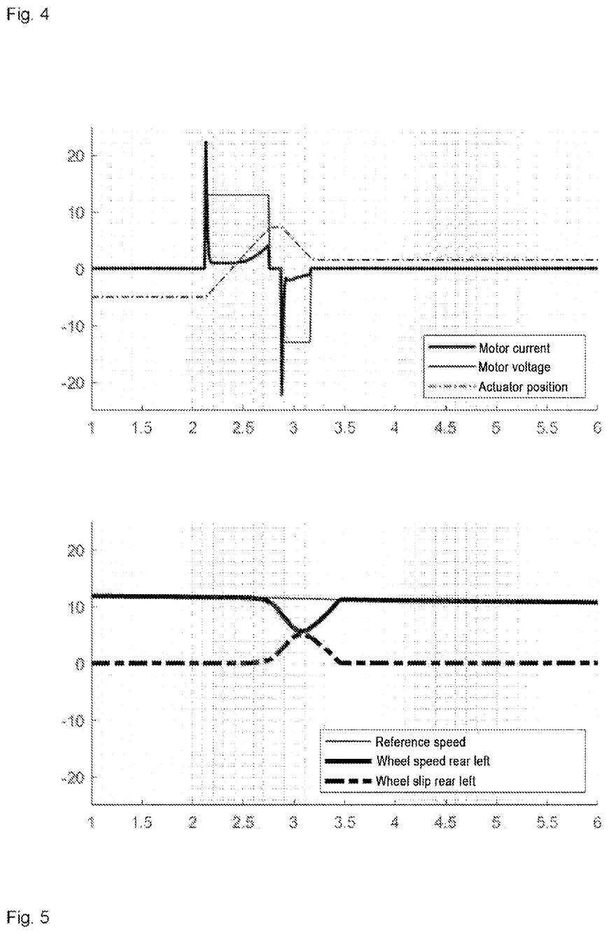

The further FIGS. 2-4 show a procedure/routine developed further for the improved operation of a correspondingly better equipped electric parking brake system EPB in the vehicle driving mode. Although the embodiments are recommended for integrated braking systems as in FIG. 1, an application or extension to parking brake systems with an independently arranged parking brake electronic unit (ECU) EPB-ECU is conceivable, and is in principle sought for the sake of completeness. A further development relates to a special parking brake readiness position as an actuator specification/actuator function, wherein this special parking brake readiness position (on the basis of a release clearance defined as required and/or on a case-by-case basis and/or arranged in a specially defined and limited manner) is automatically provided as required in a current vehicle driving mode—for example verified by the ESC host and requested and provided in the EPB braking system.

The embodiments include an electromechanical actuator/geared motor drive train of an electric parking brake EPB that makes possible and undergoes for the first time, in an automated and preparatory manner, a special release clearance conditioning—namely, brake preparation action—by means of a special actuator positioning, while the motor vehicle in question without a braking request is thus still in an unbraked motor vehicle driving mode assessed to be free from hazards. In other words, a preparatory measure in the sense of an electric parking brake actuator conditioning is carried out in an unbraked vehicle driving state to thereby enable an implementation of a possibly subsequent, future (potential) brake actuation request, which is to be carried out according to plan as a dynamic brake actuation—i.e. while out of or in the current vehicle driving mode—by the electric parking brake EPB as well as on a special request (such as in particular by an ESC host and/or automatically or initiated at the driver's request). A parking brake actuator current rises when approaching a touchpoint is not (solely) included as the sole criterion for assessing and carrying out a release clearance routine for parking brake control/parking brake regulation, but at least one (and/or more) measured and/or determined vehicle driving parameters are fed to an ECU in the current vehicle driving mode and processed, i.e., included, without there being a service brake or parking brake actuation request from a vehicle driver or automatically. The release clearance routine therefore for example includes a vehicle travel data comparison such as measurement, detection, determination and/or evaluation of a wheel slip value and/or actuator current of the brake rotor (brake disk or brake drum), which is in each case acted upon by the electric parking brake. The embodiments are therefore generally recommended for any braking system, namely motor vehicle friction brake types, and equally for, for example, disk brake systems and/or drum brake systems which are improved in terms of driving stability/safety.

A system can in principle be configured adjustably, for example down to a lowermost vehicle level, i.e. can be designed so as to be flexibly configurable in a manner tailored to the individual vehicle. Accordingly, it is conceivable, in a further development, to configure an electronic parking brake system on the basis of different conceivable adjustment modifications, which can depict very specific predetermined definable vehicle driving modes and/or vehicle driving modes individually configurable by a customer and/or vehicle driver. In this context, for example, it is made possible to predetermine a gradually adapted release clearance specification as required, and to impart it to an electric parking brake actuator, in such a way that a slightly increased release clearance specification is produced for a efficiency-oriented “eco mode”, in order to ensure that residual braking torques can be excluded in a fully reliable manner, whereas, moreover, a gradually reduced release clearance specification as a target value can be made possible for, by way of example, a sporty-activity-oriented “sports mode”, so that a particularly intensified brake actuation behavior can be generated.

It is understood that a modified release clearance specification for all the electric parking brake calipers of a common vehicle axle can be defined uniformly and/or as a general boundary condition. Irrespective of this, however, it is also possible to develop a wheel-brake-specific configuration with a wheel-brake-specific release clearance routine/release clearance specification/release clearance dimensioning and to impart it to the actuators. These specifications can be checked, modified and/or refined or readjusted according to the type of control circuit on the basis of the vehicle driving state data, for example by way of example on the basis of wheel slip values obtained in a wheel-specific manner. This approach allows that in addition to wheel rotation speed sensor systems already present on a wheel-specific basis, no additional expensive sensor systems are required in principle (dual-use bonus effect).

Finally, it is possible as well as expedient to provide one or more mechanical restoring spring means in order to impart an endeavor for a release clearance to an actuator and/or friction lining, by way of example currentlessly and in the manner of a drive, or to convey, i.e. to drive, the endeavor for the release clearance position. This may include what is referred to as an active and spring-elastically preloaded (“charged”) release clearance spring as a spring accumulator in the sense of a function as a friction lining restoring spring, which may be suitable and intended to act upon a friction lining in such a way that an at least minor elastic restoring force, the force effect of which is oriented substantially diametrically opposed to an applied brake application force, is imparted permanently to a friction lining. A combination in conjunction with a roll-back brake piston seal is possible or expedient in a supporting, alternative or complementary way thereto.

In a developed specification, a motor vehicle wheel brake may also have a mechanically currentless restoring spring means which is elastically preloaded with preloading force for the purpose of providing the release clearance/imparting the release clearance, which means is held by way of example elastically deformed in a groove in a combined hydraulically and electromechanically actuable parking brake caliper, and is defined as a roll-back sealing ring, which can act on a hydraulically actuable brake piston in the drive train of the electromechanical actuator adjustment device in such a way that a fundamentally resilient desired restoring positioning is imparted to the actuator train or its friction lining currentlessly and counter to its brake application direction of force. An automatic as well as currentless compensation for wear can additionally be made possible, if at least one restoring spring means arranged in an elastically preloaded manner is configured so as to be plastically deformable in a defined manner depending on the wear travel (depending on an actuation travel extension). In the preceding embodiments, it is understood that the electronic control unit (ECU) supports a suitable control integration of the one or more mechanical restoring (spring) means in a suitably purposeful way, i.e. includes this and the effect thereof, without of course departing from a primary essence of the embodiments.

1. A method for activating an electromechanical actuator for an electric wheel brake in a motor vehicle comprising:
adjusting a brake lining by energizing a reversible electromotive actuator in a brake actuation direction with an electronic unit in a first activation step, wherein the brake lining contacts a brake rotor with a slight touching such that there is no significant frictional power;
detecting the contact automatically with the electronic unit then terminating the energizing of the actuator with the electronic unit;
resetting the brake lining in a brake release direction by reversed energizing of the actuator with the electronic unit in a second automatic activation step such that there is a defined release clearance hairline gap between the brake lining and the brake rotor; and
terminating the second activation step automatically by braking the actuator with a subsequent interruption of the energizing of the actuator with the electronic unit.

2. The method as claimed in claim 1, further comprising monitoring and evaluating sensor data of at least one sensor with the electronic unit to at least one of carry out and terminate the first and second activation steps.

3. The method as claimed in claim 2, wherein at least one of a change in the sensor data and a gradient change of the sensor data initiates at least one of the first and second activation steps.

4. The method as claimed in claim 2, wherein the sensor data of at least one sensor relates to at least one of:
the actuator;
a physical actuator state variable;
an actuator current;
an actuator actuating travel of the actuator;
an actuator force; and
a gradient of the physical actuator state variable, the actuator current, the actuating travel of the actuator, or the actuator force.

5. The method as claimed in claim 2, wherein the sensor data of the at least one sensor relates to at least one of: a physical wheel braking state variable, a wheel braking force variable, a wheel braking torque variable, a gradient of the wheel braking state variable, a gradient of the wheel braking force, and gradient of the wheel braking torque.

6. The method as claimed in claim 2, wherein the sensor data of the at least one sensor relates to at least one of:
a physical motor vehicle driving state,
a vehicle acceleration,
a vehicle deceleration,
a wheel rotational speed,
a wheel acceleration,
a steering angle,
a yaw angle, and
a gradient of the physical motor vehicle driving state, the vehicle acceleration, the deceleration, the wheel rotational speed, the wheel acceleration, the steering angle or the yaw angle.

7. The method as claimed in claim 1, further comprising short-circuiting the actuator electrically in the unbraked wheel braking state with the electronic unit to maintain the set release clearance hairline gap.

8. The method as claimed in claim 1, further comprising providing an electromotive parking brake actuator drive train in a currentlessly self-locking manner in the unbraked wheel braking state in order to maintain the defined release clearance hairline gap.

9. The method as claimed in claim 1, further comprising providing sensor data fusion in the electronic unit for controlling the actuator to enable at least one of the contacting and resetting.

10. A reversible electromechanical motor vehicle wheel brake comprising:
an electromotive actuator on a brake stator, with a gear adjustment device for actuating and holding at least one brake lining in the direction of a brake rotor;
at least one electrical plug-in interface for electrical connection
an electronic unit connectable the actuator via the interface, wherein the electronic unit has instructions for:
adjusting a brake lining by energizing the actuator in a brake actuation direction in a first activation step, wherein the at least one brake lining contacts the brake rotor with a slight touching such that there is no significant frictional power;
detecting the contact automatically and thereby terminating the energizing of the actuator;
resetting the brake lining in a brake release direction by reversed energizing of the actuator in a second automatic activation step such that there is a defined release clearance hairline gap between the brake lining and the brake rotor; and
terminating the second activation step automatically by braking the actuator with a subsequent interruption of the energizing of the actuator.

11. The reversible electromechanical motor vehicle wheel brake, as claimed in claim 10, further comprising an elastically preloaded restoring spring which provides a force on the at least on a friction lining such that the force of the restoring spring is directed diametrically to an actuator application force.

12. The reversible electromechanical motor vehicle wheel brake, which is connectable to an electronic unit, as claimed in claim 11, the restoring spring provides the release clearance gap, and wherein the restoring spring is held elastically deformed in a groove defined by the brake caliper such that a restoring force is imparted to the actuator currentlessly and counter to its brake application direction of force.

13. The reversible electromechanical motor vehicle wheel brake as claimed in claim 11, wherein the restoring spring is arranged in an elastically preloaded manner so as to be plastically deformable to automatically compensate for wear.
